(19) United States
(12) Patent Application Publication
(10) Pub. No.: US 2025/0168294 A1
(43) Pub. Date: May 22, 2025

(54) ELECTRONIC EQUIPMENT, PROGRAM

(71) Applicant: SONY SEMICONDUCTOR SOLUTIONS CORPORATION, KANAGAWA (JP)

(72) Inventor: MASAAKI TAKESUE, KANAGAWA (JP)

(21) Appl. No.: 18/838,350

(22) PCT Filed: Jan. 5, 2023
(86) PCT No.: PCT/JP2023/000105

§ 371 Date: Aug. 14, 2024

(30) Foreign Application Priority Data
Feb. 22, 2022 (JP) 2022-025748

(51) Int. Cl. H04N 7/035; H04N 7/18

(52) U.S. Cl. CPC H04N 7/0352; H04N 7/183

(57) ABSTRACT

Electronic equipment includes a wireless communication section that performs wireless communication using a band including a predetermined frequency and a pixel array section that transfers pixel data at a transfer rate corresponding to the predetermined frequency.

### TECHNICAL FIELD

The present technology relates to electronic equipment and a program, and in particular, to a technology for electronic equipment and a program in which processing for transferring pixel data from a pixel array section is executed simultaneously with communication processing in wireless communication.

### BACKGROUND ART

In electronic equipment such as an imaging apparatus including a pixel array section and being capable of wireless communication, when pixel data is read from each of the pixels in the pixel array section and externally transferred, an electromagnetic wave is generated according to a transfer rate, and an electromagnetic wave is generated according to a communication frequency used in the wireless communication. There have been developed technologies that are used to suppress electromagnetic interference caused by such electromagnetic waves to prevent various functions from being affected by the electromagnetic interference.

For example, PTL 1 listed below discloses a technology for determining whether or not an image capturing state of the imaging apparatus is likely to be susceptible to noise and limiting wireless communication to be performed at appropriate timings in order to prevent recorded images from containing noise caused by electromagnetic interference.

### CITATION LIST

### Patent Literature

[PTL 1]

Japanese Patent Laid-Open No. 2011-130373

### SUMMARY

### Technical Problem

However, this method restrains noise from being contained in recorded images but fails to avoid wireless communication being subjected to electromagnetic interference caused by transfer of pixel data.

The present technology is intended to solve the above-described problem, and an object of the present technology is to suppress electromagnetic interference with wireless communication caused by transfer of pixel data from the pixel array section.

### Solution to Problem

Electronic equipment according to the present technology includes a wireless communication section that performs wireless communication using a band including a predetermined frequency and a pixel array section that transfers pixel data at a transfer rate corresponding to the predetermined frequency.

Thus, pixel data can be transferred at a transfer rate at which wireless communication is less likely to be affected, in other words, at a transfer rate at which wireless communication is less likely to be subjected to electromagnetic interference.

### BRIEF DESCRIPTION OF DRAWINGS

FIG. 1 is a block diagram illustrating a configuration example of electronic equipment of the present technology.

FIG. 2 is a diagram for describing a flow of processing for wireless communication and transfer of pixel data.

FIG. 3 is a diagram for describing a flow of processing in sections of the electronic equipment.

FIG. 4 is a diagram for describing a flow of processing for wireless communication and transfer of pixel data according to a second embodiment.

FIG. 5 is a diagram for describing a flow of processing in the sections of the electronic equipment according to the second embodiment.

FIG. 6 is a diagram for describing a flow of processing for wireless communication and transfer of pixel data according to a third embodiment.

FIG. 7 is a diagram for describing a flow of processing in the sections of the electronic equipment according to the third embodiment.

### DESCRIPTION OF EMBODIMENTS

Embodiments will be described below in the following order.
<1. Configuration of Electronic Equipment>
<2. Flow of Processing>
<3. Second Embodiment>
<4. Third Embodiment>
<5. Variation>
<6. Conclusion>
<7. Present Technology>

### 1. Configuration of Electronic Equipment

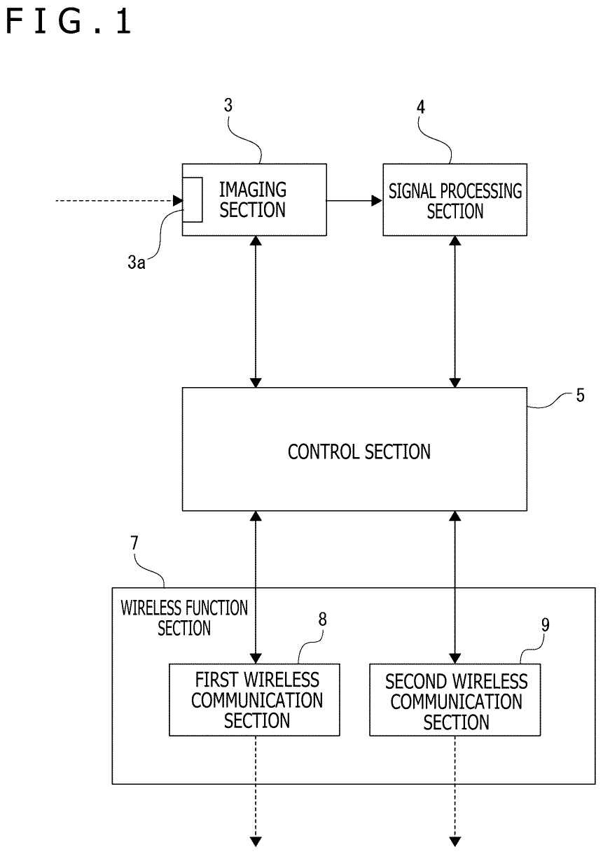

A configuration of electronic equipment 1 according to the present technology will be described with reference to FIG. 1.

The electronic equipment 1 includes an imaging section 3, a signal processing section 4, a control section 5, and a wireless function section 7.

Note that the electronic equipment 1 may include a group of various lenses, drivers, and the like as an imaging optical system as necessary.

The imaging section 3 includes a pixel array section 3a including a light receiving surface on which pixels including photoelectric conversion elements such as photodiodes are two-dimensionally arranged, and a readout circuit that reads out electric signals obtained by photoelectric conversion from respective pixels provided in the pixel array section 3a, and is enabled to output the electric signals as pixel data.

The readout circuit executes, for example, CDS (Correlated Double Sampling) processing, AGC (Automatic Gain Control) processing, or the like, on the electric signals obtained by photoelectric conversion, and further executes A/D (Analog/Digital) conversion processing.

The signal processing section 4 executes preprocessing, synchronization processing, YC generation processing, resolution conversion processing, codec processing, and the like on the pixel data as digital data resulting from A/D conversion processing.

In the preprocessing, the signal processing section 4 executes, on the pixel data, clamp processing for clamping black levels of R, G, and B at predetermined levels, correction processing between color channels of R, G, and B, and the like. In the synchronization processing, the signal processing section 4 executes color separation processing in such a manner that image data for each pixel has all color components of R, G, and B. For example, imaging elements using color filters in a Bayer pattern execute demosaic processing as color separation processing. In the YC generation processing, the signal processing section 4 generates (separates) luminance (Y) signals and color (C) signals from image data of R, G, and B. In the resolution conversion processing, the signal processing section 4 executes resolution conversion processing on image data subjected to various types of signal processing.

In the codec processing, the signal processing section 4 executes, for example, coding processing for recording or communication or file generation on the image data subjected to the various types of processing described above. The codec processing is enabled, for example, to generate files in such video file formats as MPEG-2 (MPEG: Moving Picture Experts Group) and H. 264. Further, the codec processing may include generating still image files in such formats as JPEG (Joint Photographic Experts Group), TIFF (Tagged Image File Format), and GIF (Graphics Interchange Format).

The control section 5 provides instructions to the imaging section 3 to control execution of imaging operations. Similarly, the control section 5 also transmits instructions to the signal processing section 4 to control execution of processing.

The control section 5 executes processing for determining a transfer rate for pixel data output from the imaging section 3. Specifically, the control section 5 determines the transfer rate according to a communication frequency used in wireless communication performed by the wireless function section 7, to reduce electromagnetic interference with the wireless communication. Further, the control section 5 controls output from the imaging section 3 to allow the pixel data to be transferred at the determined transfer rate.

The control section 5 may calculate the transfer rate for pixel data for each processing operation or may select the transfer rate by using table data in which the communication frequency used in the wireless communication is associated with the transfer rate for pixel data.

The transfer rate corresponding to the communication frequency used in the wireless communication may be a transfer rate at which, for example, a third harmonic that is a threefold frequency or a fifth harmonic that is a fivefold frequency is not close to the communication frequency used in the wireless function section 7, or the like.

In addition, radio frequency radiation and a standing wave that are likely to occur vary depending on a circuit pattern of a transfer circuit for transferring data from the pixel array section 3a and the imaging section 3. The transfer rate is desirably determined in such a manner as to prevent the radio frequency radiation and standing wave that are likely to occur from being close to the communication frequency.

The wireless function section 7 comprehensively represents a processing section for performing various kinds of wireless communication, and in an example in FIG. 1, includes a first wireless communication section 8 and a second wireless communication section 9. Note that the wireless function section 7 may include one wireless communication section or may include three or more wireless communication sections.

The first wireless communication section 8 and the wireless communication section 9 perform wireless communication based on different standards. For example, the first wireless communication section 8 and the wireless communication section 9 each function as one of various kinds of wireless communication including near-field communication such as WiFi (registered trademark), Bluetooth (registered trademark), and BLE (Bluetooth Low Energy), mobile communication such as 4G (4th Generation), 5G (5th Generation), and 6G (6th Generation), and wireless communication related to satellite signals in a GNSS (Global Navigation Satellite System).

The first wireless communication section 8 and the second wireless communication section 9 are each enabled to communicate using at least one of multiple communication channels corresponding to predetermined bandwidths into which a communication band specified by the respective wireless communication standard is separated.

The first wireless communication section 8 and the second wireless communication section 9 communicate wirelessly using the determined communication channel, but the communication channel may be changed depending on the situation.

In a case where the communication channel that is used by the first wireless communication section 8 and the second wireless communication section 9 is changed, the control section 5 may change the transfer rate for pixel data according to the communication channel resulting from the change.

### 2. Flow of Processing

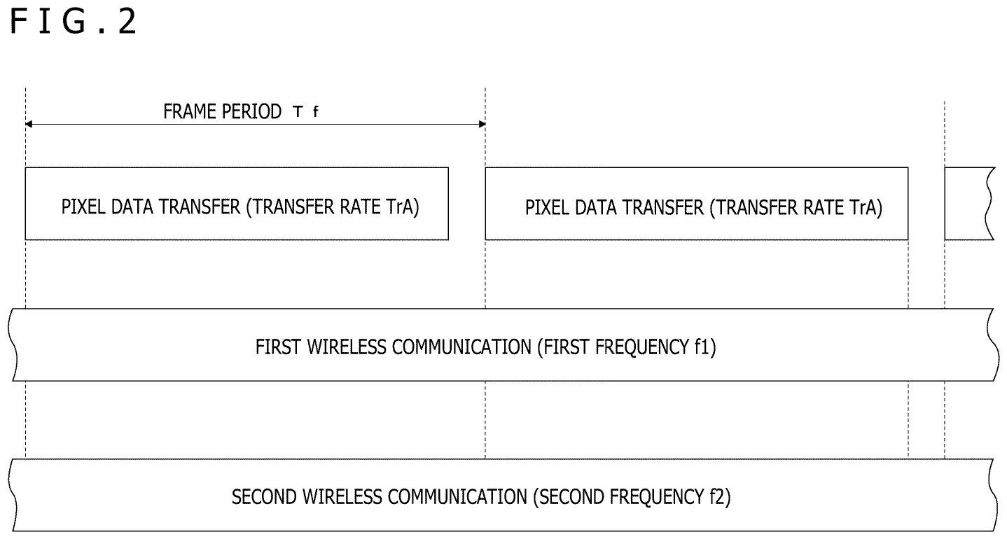

With reference to FIG. 2, a flow of processing for wireless communication and transfer of pixel data will be described.

As illustrated, at each period determined according to an imaging operation for one frame and beginning at the start of transfer of pixel data (hereinafter simply described as a “frame period Tf”), pixel data is transferred (read out) from the pixel array section 3a at the transfer speed of a transfer rate TrA.

Here, the transfer rate TrA is determined by the control section 5 according to a first frequency f1 that is a communication frequency of first wireless communication and a second frequency f2 that is a communication frequency of second wireless communication.

At the transfer rate TrA, the first frequency f1 and the second frequency f2 are less likely to cause electromagnetic interference with the wireless communication, thus enabling the wireless communication to be executed normally even when the transfer of pixel data is performed in parallel with the first wireless communication and the second wireless communication.

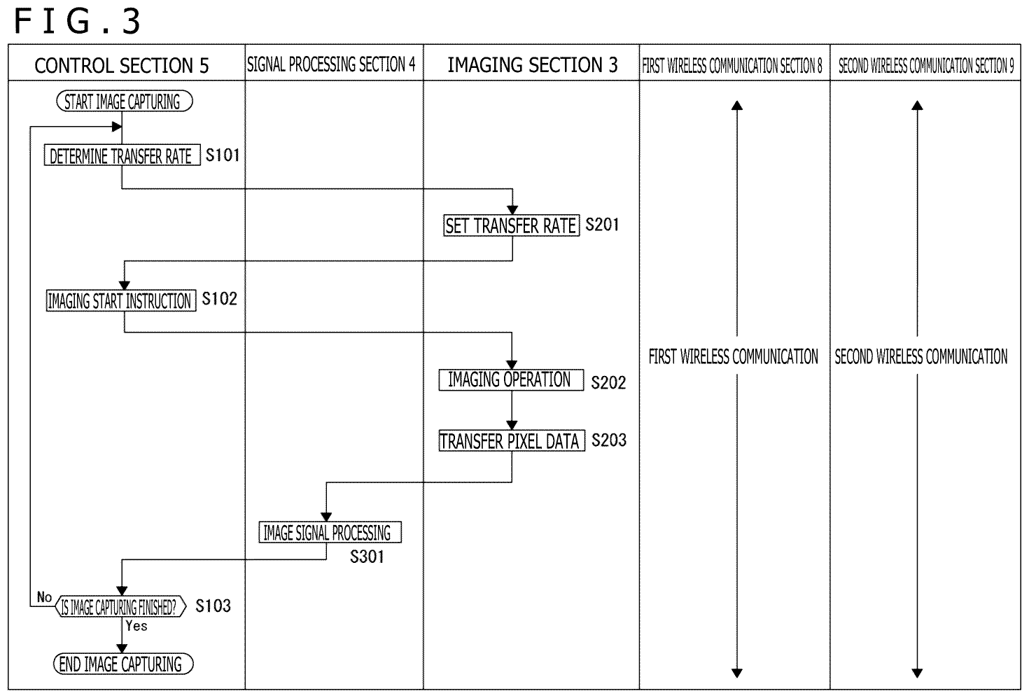

FIG. 3 illustrates a flow of processing in the control section 5, the signal processing section 4, the imaging section 3, the first wireless communication section 8, and the second wireless communication section 9 in the present example.

First, when image capturing in the electronic equipment 1 is started, the control section 5 determines, in step S101, the transfer rate TrA for pixel data according to the communication frequency used in the wireless communication by the first wireless communication section 8 (first frequency f1) and the communication frequency used in the wireless communication by the second wireless communication section 9 (second frequency f2).

Upon determining the transfer rate TrA, the control section 5 notifies the imaging section 3 of the determined transfer rate TrA.

Upon receiving the notification, the imaging section 3 sets the transfer rate TrA in step S201.

Upon completing the setting of the transfer rate TrA, the imaging section 3 transmits a setting complete notification to the control section 5.

Upon receiving the setting complete notification, the control section 5 transmits an imaging start instruction to the imaging section 3 in step S102.

In step S202, the imaging section 3 performs an imaging operation, and in step S203, transfers the pixel data to the signal processing section 4, which follows the imaging section 3.

Upon receiving the pixel data, the signal processing section 4 executes image signal processing in step S301.

In step S103, the control section 5 executes processing for determining whether or not the image capturing is finished, for example, determination processing based on whether or not the user has depressed an image capturing end button, or the like, and in a case of determining that the image capturing has not been finished, returns to the processing in step S101 again.

On the other hand, in a case where the image capturing is determined to have been finished, the control section 5 ends the series of processing operations illustrated in FIG. 3.

As described above, since the transfer of pixel data at the transfer rate TrA is made less likely to cause electromagnetic interference with each wireless communication, the first wireless communication by the first wireless communication section 8 and the second wireless communication by the second wireless communication section 9 can be performed with no problem from start to end of the image capturing as illustrated in FIG. 3.

### 3. Second Embodiment

In contrast to the example described above, electronic equipment 1 according to a second embodiment includes, between the start and end of the image capturing, a period in which the first wireless communication by the first wireless communication section 8 and the second wireless communication by the second wireless communication section 9 fail to be performed.

Functional blocks of the electronic equipment 1 are similar to those in the example described above and are as illustrated in FIG. 1.

A difference from the example described above is that the control section 5 can instruct the first wireless communication section 8 and the second wireless communication section 9 of the wireless function section 7 to stop the wireless communication.

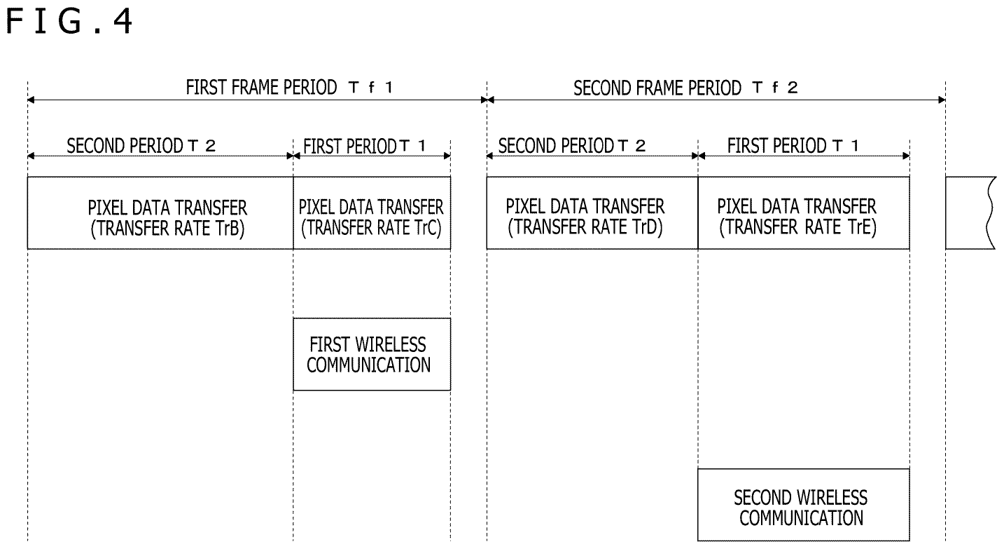

With reference to FIG. 4, a flow of processing related to wireless communication and transfer of pixel data will be described.

As illustrated, during a first frame period Tf1, the first wireless communication is performed in parallel with the transfer of pixel data, and during a second frame period Tf2, the second wireless communication is performed in parallel with the transfer of pixel data.

The first frame period Tf1 in the present example is divided into a first period T1 in which the wireless communication (first wireless communication) is performed simultaneously with the transfer of pixel data and a second period T2 in which the first wireless communication and the second wireless communication are prohibited in connection with the transfer of pixel data.

For example, a substantially former half portion of the first frame period Tf1 is designated as the second period T2, and the first wireless communication and the second wireless communication are both prohibited. Further, the transfer of pixel data during the second period T2 is performed at a transfer rate TrB.

A substantially latter half portion of the first frame period Tf1 is designated as the first period T1, and the first wireless communication is performed in parallel. Further, the transfer of pixel data during the first period T1 is performed at a transfer rate TrC.

Several manners are possible for determining the transfer rate TrB and the transfer rate TrC.

For example, the transfer rate TrB may be determined by determining the length of the first period T1 according to the time length required for completing communication of a predetermined amount of data in the first wireless communication, and calculating a data transfer speed required for transferring pixel data for one frame during the length of the second period T2 naturally determined according to the length of the first period T1.

Alternatively, the transfer rate TrB may be determined to be as high data transfer speed as possible to make the second period T2 as short as possible, and the transfer rate TrC that enables pixel data which has not yet been transferred to be transferred during the first period T1, which is the remaining time in the first frame time Tf1, and that is less likely to cause electromagnetic interference with the first frequency f1 may be determined.

Similarly to the first frame period Tf1, the second frame period Tf2 subsequent to the first frame period Tf1 is divided into a first period T1 in which the wireless communication (second wireless communication) is performed simultaneously with the transfer of pixel data and a second period T2 in which the first wireless communication and the second wireless communication are prohibited in connection with the transfer of pixel data.

For example, a substantially former half portion of the second frame period Tf2 is designated as the second period T2, and the first wireless communication and the second wireless communication are both prohibited. Further, the transfer of pixel data during the second period T2 is performed at a transfer rate TrD.

A substantially latter half portion of the second frame period Tf2 is designated as the first period T1, and the second wireless communication is performed in parallel. Further, the transfer of pixel data during the first period T1 is performed at a transfer rate TrE.

As is the case with the transfer rate TrB and the transfer rate TrC, several manners are possible for determining the transfer rate TrD and the transfer rate TrE.

Note that, in FIG. 4, the substantially former half portion of each frame period Tf is designated as the second period T2, whereas the substantially latter half portion of each frame period Tf is designated as the first period T1 but that the substantially former half portion of the frame period Tf may be designated as the first period T1 in which the wireless communication is performed in parallel, whereas the substantially latter half portion of the frame period Tf may be designated as the second period T2.

The transfer rates TrC and TrE for the first period T1 are determined to minimize electromagnetic interference with the wireless communication. Meanwhile, the transfer rates TrB and TrD for the second period T2 can be determined without considering the constraint as described above, and can be set to higher values than the transfer rates TrC and TrE for the first period T1.

The transfer rate TrC and the transfer rate TrE required for completing transfer of pixel data for one frame can be reduced by increasing the transfer rate TrB more than the transfer rate TrC and increasing the transfer rate TrD more than the transfer rate TrE. This preferably enables widening of the ranges of the transfer rates that can be selected to reduce electromagnetic interference.

Note that the control section 5 recognizes that, at the start of the first frame period Tf1, the first wireless communication carries a data communication request, and can thus determine the transfer rate TrB and the transfer rate TrC. Further, the control section 5 recognizes that, at the start of the second frame period Tf2, the second wireless communication carries a data communication request, and can thus determine the transfer rate TrD and the transfer rate TrF.

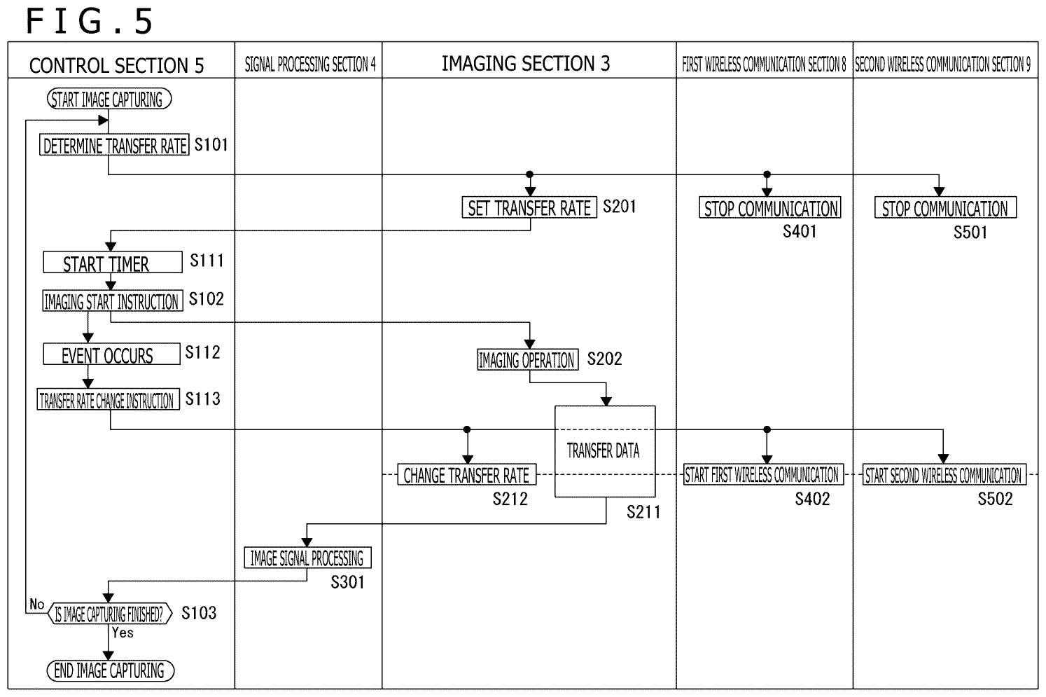

FIG. 5 illustrates a flow of processing in the control section 5, the signal processing section 4, the imaging section 3, the first wireless communication section 8, and the second wireless communication section 9 in the present example.

First, when image capturing in the electronic equipment 1 is started, the control section 5 determines, in step S101, the transfer rate for pixel data for the second period T2 according to a communication frequency used in wireless communication by the first wireless communication section 8 (first frequency f1) or a communication frequency used in wireless communication by the second wireless communication section 9 (second frequency f2).

The transfer rate determined in this case varies between a case where a data communication request based on first wireless communication is made and a case where a data communication request based on second wireless communication is made. Specifically, in a case where the data communication request based on the first wireless communication is made, the transfer rate TrB is determined according to the transfer rate TrC determined according to the first frequency f1. In a case where the data communication request based on the second wireless communication is made, the transfer rate TrD is determined according to the transfer rate TrE determined according to the second frequency f2 (see FIG. 4).

Upon determining the transfer rate TrB or the transfer rate TrD for the second period T2, the control section 5 notifies the imaging section 3 of the determined transfer rate.

Upon receiving the notification, the imaging section 3 sets the transfer rate in step S201.

Upon completing the setting of the transfer rate, the imaging section 3 transmits a setting complete notification to the control section 5.

Further, the control section 5 transmits a communication stop command to the first wireless communication section 8 and the second wireless communication section 9 simultaneously with the notification to the imaging section 3.

In response, the first wireless communication section 8 stops the first wireless communication in step S401, and the second wireless communication section 9 stops the second wireless communication in step S501.

Note that the processing for stopping the wireless communication in step S401 and step S501 may be executed immediately before data transfer in subsequent step S211 is started. For example, the control section 5 may transmit the stop command after the imaging start instruction is given in step S102. This allows extension of a period in which wireless communication is enabled.

In step S111, the control section 5 starts (sets) a timer. The timer is determined according to the time length of the second period T2, and the time may vary depending on which of the transfer rates TrB and TrD has been set as the transfer rate for pixel data.

After the timer is started, the control section 5 transmits the imaging start instruction to the imaging section 3 in step S102.

The imaging section 3 performs an imaging operation in step S202, and starts, in step S211, transferring pixel data to the signal processing section 4 following the imaging section 3.

In parallel with the data transfer, the control section 5 performs timer control, and an event occurs according to a set time. The event is a change event for the transfer rate.

Specifically, in response to occurrence of the event based on the timer control in step S112, the control section 5 transmits a change instruction for the transfer rate in step S113. The change instruction is an instruction for changing the transfer rate TrB to the transfer rate TrC or changing the transfer rate TrD to the transfer rate TrE.

In response to the change instruction for the transfer rate, the imaging section 3 changes the transfer rate in step S212. That is, the transfer rate is changed during the data transfer in step S211.

Further, according to the change instruction for the transfer rate, the control section 5 transmits a start instruction for wireless communication to the first wireless communication section 8 or the second wireless communication section 9.

For example, in a case where the transfer rate TrB is changed to the transfer rate TrC, the control section 5 transmits a start instruction for wireless communication to the first wireless communication section 8.

In response, the first wireless communication section 8 executes processing for starting the first wireless communication in step S402.

Alternatively, in a case where the transfer rate TrD is changed to the transfer rate TrE, the control section 5 transmits a start instruction for wireless communication to the second wireless communication section 9.

In response, the second wireless communication section 9 executes processing for starting the second wireless communication in step S502.

Upon receiving the pixel data from the imaging section 3 according to the data transfer in step S211, the signal processing section 4 executes image signal processing in step S301.

In step S103, the control section 5 executes processing for determining whether or not image capturing is finished, for example, determination processing based on whether or not the user has depressed the image capturing end button, or the like. In a case of determining that the image capturing is not finished, the control section 5 returns to the processing in step S101 again.

On the other hand, in a case of determining that the image capturing is finished, the control section 5 ends the series of processing operations illustrated in FIG. 5.

### 4. Third Embodiment

In contrast to the example described above, the electronic equipment 1 according to a third embodiment executes transfer processing for pixel data and wireless communication in a time division manner.

Functional blocks of the electronic equipment 1 are similar to those in the example described above and are as illustrated in FIG. 1.

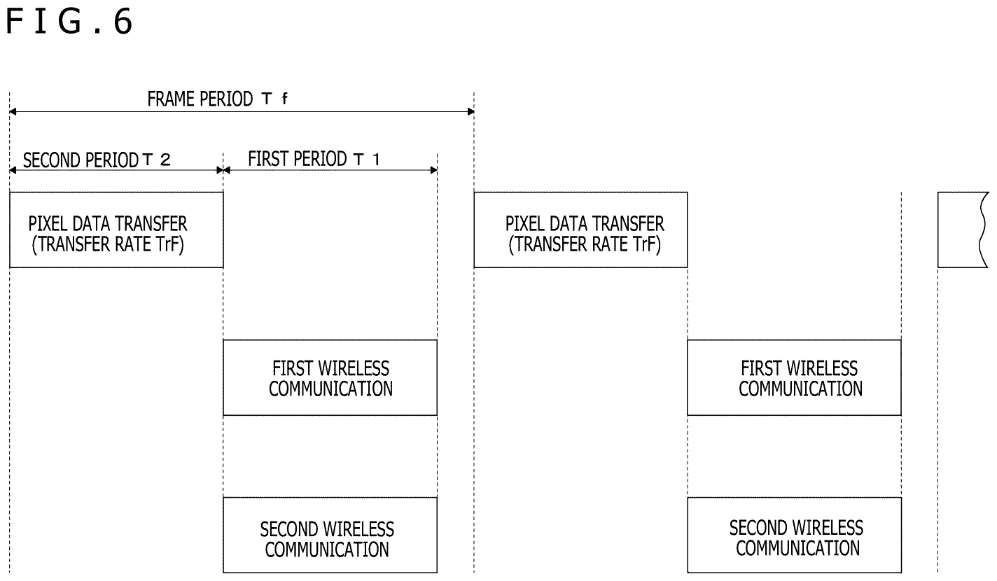

With reference to FIG. 6, a flow of processing for wireless communication and transfer of pixel data will be described.

As illustrated, while pixel data is being transferred (first period T1), the first wireless communication and the second wireless communication are stopped. Further, while no pixel data is being transferred (second period T2), the first wireless communication or the second wireless communication is enabled. Note that data transmission or reception may simultaneously be performed in the first wireless communication and the second wireless communication.

For the transfer rate for the transfer of pixel data from the pixel array section, the control section 5 desirably sets as high transfer rate TrF as possible.

The transfer rate TrF of a large value allows the transfer processing for pixel data for one frame to be completed quickly, enabling extension of the period in which the wireless communication is permitted (that is, the second period T2).

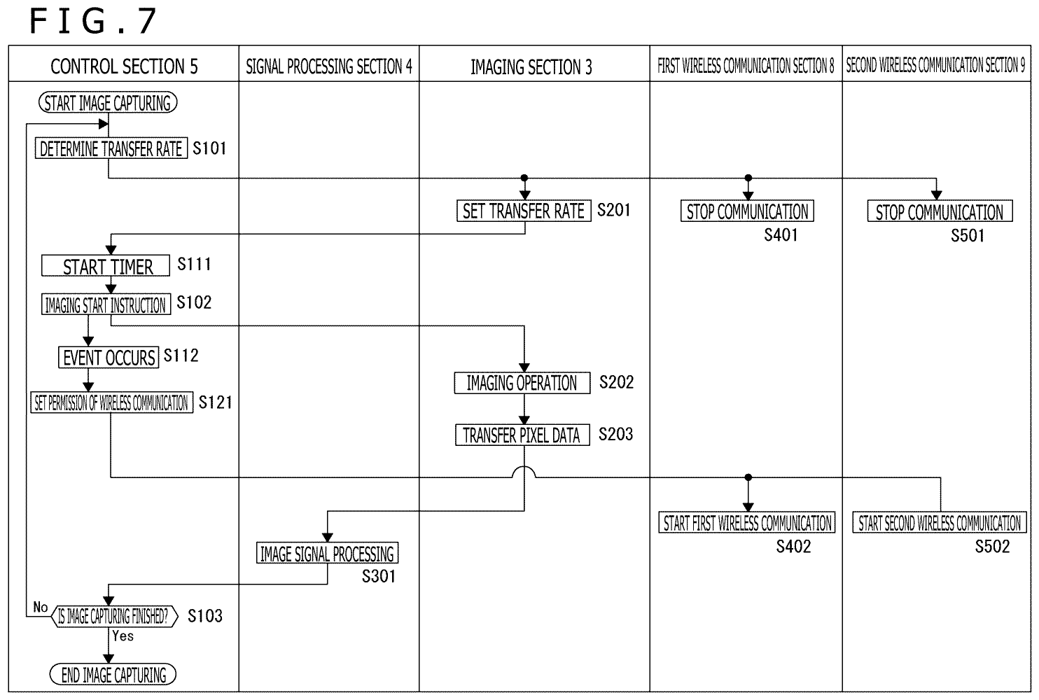

FIG. 7 illustrates a flow of processing in the control section 5, the signal processing section 4, the imaging section 3, the first wireless communication section 8, and the second wireless communication section 9 in the present example.

First, when image capturing in the electronic equipment 1 is started, the control section 5 determines as high transfer rate TrF as possible in step S101.

Note that, in a case where it is difficult to set a transfer rate that does not cause electromagnetic interference affecting the first wireless communication using the first frequency f1 or the second wireless communication using the second frequency f2, the transfer rate TrF may be specified when the wireless communication and the transfer of pixel data are determined to be performed in a time division manner. Further, the transfer rate TrF in this case can be considered as a transfer rate determined according to the first frequency f1 or the second frequency f2.

Upon determining the transfer rate TrF for the second period T2, the control section 5 notifies the imaging section 3 of the determined transfer rate.

Upon receiving the notification, the imaging section 3 sets the transfer rate TrF in step S201.

Upon completing the setting of the transfer rate TrF, the imaging section 3 transmits the setting complete notification to the control section 5.

Further, the control section 5 transmits the communication stop command to the first wireless communication section 8 and the second wireless communication section 9 simultaneously with the notification to the imaging section 3.

In response, the first wireless communication section 8 stops the first wireless communication in step S401, and the second wireless communication section 9 stops the second wireless communication in step S501. Note that the stop command for the wireless communication from the control section 5 may be transmitted immediately before the transfer of pixel data is started as described in the second embodiment.

In step S111, the control section 5 starts (sets) a timer. The timer is determined according to the time length of the second period T2, and is set according to the transfer rate TrF for pixel data.

After the timer is started, the control section 5 transmits the imaging start instruction to the imaging section 3 in step S102.

The imaging section 3 performs an imaging operation in step S202, and starts, in step S203, transferring pixel data to the signal processing section 4 following the imaging section 3.

In parallel with the data transfer, the control section 5 performs timer control, and an event occurs according to a set time. The event is a permission event for the wireless communication.

Specifically, in response to occurrence of the event based on the timer control in step S112, the control section 5 transmits an instruction permitting wireless communication to the first wireless communication section 8 or the second wireless communication section 9 in step S121.

In response, in a case where the first wireless communication is to be performed, the first wireless communication section 8 executes processing for starting the first wireless communication in step S402.

Alternatively, in a case where the second wireless communication is to be performed, the second wireless communication section 9 executes processing for starting the second wireless communication in step S502.

Upon receiving pixel data from the imaging section 3 in step S203, the signal processing section 4 executes image signal processing in step S301.

In step S103, the control section 5 executes processing for determining whether or not image capturing is finished, for example, determination processing based on whether or not the user has depressed the image capturing end button, or the like. In a case of determining that the image capturing is not finished, the control section 5 returns to the processing in step S101 again.

On the other hand, in a case of determining that the image capturing is finished, the control section 5 ends the series of processing operations illustrated in FIG. 7.

### 5. Variation

The electronic equipment 1 in the various examples described above includes one imaging section 3 but may include multiple imaging sections 3. In the electronic equipment 1 including the multiple imaging sections 3, the respective pixel array sections 3a frequently transfer pixel data, and thus the electronic equipment 1 frequently emits electromagnetic waves. At this time, adjustment of the transfer rate related to the transfer of pixel data can make the wireless communication less likely to be affected by electromagnetic interference, allowing realization of an environment in which preferable communication is enabled. That is, the amount of benefits resulting from preferable selection of the transfer rate increases consistently with the number of the imaging sections 3.

### 6. Conclusion

As described above, the electronic equipment 1 includes a wireless communication section (wireless function section 7) that performs wireless communication (first wireless communication or second wireless communication) using a band including a predetermined frequency (first frequency f1 or second frequency f2), and a pixel array section 3a that transfers pixel data at a transfer rate (transfer rate TrA, TrC, TrE, TrF) corresponding to the predetermined frequency.

This enables pixel data to be transferred at a transfer rate that reduces adverse effects on the wireless communication, in other words, at a transfer rate that suppresses electromagnetic interference with the wireless communication.

Therefore, the man-hour that is required for examining sensor arrangement and arrangement of wiring patterns as measures against electromagnetic interference can be reduced. Further, the man-hour that is required for installation, electric design, structural design, development, mounting, and testing of an electromagnetic wave absorber can be reduced. Further, the number of components and the costs of the components can be reduced, allowing products to be miniaturized.

Further, the reduced man-hour shortens development time, enabling products to be brought into markets earlier.

As described in the second embodiment with reference to FIG. 4, FIG. 5, and the like, the pixel array section 3a of the electronic equipment 1 may transfer the pixel data by using different transfer rates in a first period T1 in which the wireless communication (first wireless communication or second wireless communication) is performed and in a second period T2 in which the wireless communication is not performed (transfer rate TrB and transfer rate TrC, transfer rate TrD and transfer rate TrE, or the like).

This provides a period (first period T1) in which pixel data is transferred at a transfer rate for which electromagnetic interference with the wireless communication is taken into account and a period (second period T2) in which the pixel data can be transferred with no concern for electromagnetic interference with the wireless communication. This enables avoidance of a situation in which the pixel data fails to be transferred in time at a transfer rate corresponding to a predetermined frequency (first frequency f1 or second frequency f2).

As described in the second embodiment with reference to FIG. 4, FIG. 5, and the like, the pixel array section 3a of the electronic equipment 1 may transfer the pixel data at a first transfer rate (transfer rate TrC or TrE) corresponding to the predetermined frequency (first frequency f1 or second frequency f2) in the first period T1, and may transfer the pixel data at a second transfer rate (transfer rate TrB or TrD) higher than the first transfer rate in the second embodiment T2.

That is, by transferring the pixel data at the higher transfer rate in the second period T2, the transfer of the pixel data for each frame can be completed within the period corresponding to one frame.

As described in the third embodiment with reference to FIG. 6, FIG. 7, and the like, the pixel array section 3a of the electronic equipment 1 may set a zero value for the first transfer rate to refrain from transferring the pixel data in the first period T1, while transferring the pixel data at the second transfer rate (transfer rate TrF) in the second period T2.

That is, by transferring the pixel data at the higher transfer rate in the second period T2, the transfer of the pixel data for each frame can be completed within the second period T2. Therefore, in the first period T1, the transfer of pixel data is not performed when the wireless communication (first wireless communication or second wireless communication) is performed, allowing electromagnetic interference to be eliminated.

As described in the flow of processing, the wireless communication section (wireless function section 7) of the electronic equipment 1 can use first wireless communication in which wireless communication is performed at a first frequency f1 and second wireless communication in which wireless communication is performed at a second frequency f2, and the pixel array section 3a may transfer the pixel data at a transfer rate corresponding to both the first frequency f1 and the second frequency f2.

Thus, the pixel data can be transferred at the transfer rate TrA, which suppresses electromagnetic interference in both the first wireless communication and the second wireless communication. Therefore, the pixel data can be transferred in parallel with data transmission or reception based on each type of wireless communication.

As described in the configuration example of the electronic equipment 1, the pixel array section 3a included in the imaging section 3 of the electronic equipment 1 may change the transfer rate in response to a change of a communication channel used in the wireless communication (first wireless communication or second wireless communication).

In the wireless communication, a predetermined frequency band specified by the standard is often divided into multiple channels for communication, and the communication channel in use may be changed as appropriate depending on the situation. According to the present configuration, each change in communication channel enables the transfer rate to be changed to the optimum one, allowing suppressed adverse effects on the wireless communication to be maintained.

Note that the electronic equipment 1 described above can be said to include a wireless communication section (wireless function section 7) that performs wireless communication and a pixel array section 3a that transfers pixel data at a transfer rate corresponding to the wireless communication.

This enables the transfer rate to be determined according to the communication frequency of the wireless communication performed in parallel or to be even determined depending on whether or not the wireless communication is performed in parallel, enabling reduction of electromagnetic interference with the wireless communication.

An information processing method according to the present technology is performed by an arithmetic processing apparatus (for example, electronic equipment 1 including a control section 5 and the like) by executing processing of performing wireless communication using a band including a predetermined frequency, and processing of transferring pixel data from a pixel array section at a transfer rate corresponding to the predetermined frequency.

A suitable apparatus to which such electronic equipment 1 is applied is a portable terminal apparatus such as a smartphone which is equipped with both a camera function and a wireless communication function. There has been much demand for miniaturizing such portable electronic equipment, and the camera function section and the wireless communication function section are likely to be disposed in proximity to each other. Thus, high-speed data transfer of the camera function is likely to affect the wireless communication function, and measures against electromagnetic interference are greatly demanded.

Alternatively, in a surveillance camera, imaging is constantly performed, and thus the transfer processing for pixel data is constantly executed. In such an apparatus, in a case where image data captured by the surveillance camera is transmitted to another apparatus such as a server by wireless communication, the adverse effect of electromagnetic wave noise caused by the data transfer is desirably suppressed.

By applying the electronic equipment 1 of the present technology to such a surveillance camera, acquired image data can suitably be transmitted to the server apparatus or the like with no problem, with surveillance by the surveillance camera continued.

A program executed by a computer apparatus as the electronic equipment 1 described above includes the processing operations illustrated in FIG. 3, FIG. 5, and FIG. 7, and can be prerecorded in an HDD (Hard Disk Drive) built into equipment such as a computer apparatus as a recording medium, a ROM (Read Only Memory) in a microcomputer with a CPU (Central Processing Unit), or the like. Alternatively, the program can be temporarily or permanently stored (recorded) in a removable recording medium such as a flexible disk, a CD-ROM (Compact Disk Read Only Memory), an MO (Magneto Optical) disc, a DVD (Digital Versatile Disc), a Blu-ray Disc (registered trademark), a magnetic disk, a semiconductor memory, or a memory card. Such a removable recording medium can be provided as what is generally called package software. Further, in addition to being installed in a personal computer or the like from the removal recording medium, such a program can be downloaded from a download site via a network such as a LAN or the Internet.

Note that the effects described herein are illustrative only and not restrictive and that other effects may be produced.

Further, the examples described above may be combined with one another in any manner, and the various effects described above can be produced even by using any of various combinations.

### 7. Present Technology

The present technology can also take the following configurations.

(1)

Electronic equipment including:
a wireless communication section that performs wireless communication using a band including a predetermined frequency; and
a pixel array section that transfers pixel data at a transfer rate corresponding to the predetermined frequency.
   (2)

The electronic equipment according to (1) above, in which
the pixel array section transfers the pixel data by using different transfer rates in a first period in which the wireless communication is performed and in a second period in which the wireless communication is not performed.
   (3)

The electronic equipment according to (2) above, in which
the pixel array section transfers the pixel data at a first transfer rate corresponding to the predetermined frequency in the first period, and transfers the pixel data at a second transfer rate higher than the first transfer rate in the second period.
   (4)

The electronic equipment according to (3) above, in which
the pixel array section sets a zero value for the first transfer rate to refrain from transferring the pixel data in the first period, while transferring the pixel data at the second transfer rate in the second period.
   (5)

The electronic equipment according to (1) above, in which
the wireless communication section is enabled to use first wireless communication in which wireless communication is performed at a first frequency and second wireless communication in which wireless communication is performed at a second frequency, and
the pixel array section transfers the pixel data at a transfer rate corresponding to both the first frequency and the second frequency.
   (6)

The electronic equipment according to any one of (1) through (5) above, in which
the pixel array section changes the transfer rate in response to a change of a communication channel used in the wireless communication.
   (7)

The electronic equipment according to any one of (1) through (6) above, including:
the pixel array section in plural number.
   (8)

A program readable by a computer apparatus, the program causing a computer apparatus to implement:
a wireless communication function of performing wireless communication using a band including a predetermined frequency; and
a function of transferring pixel data from a pixel array section at a transfer rate corresponding to the predetermined frequency.
   (9)

The program according to (8) above, in which
the pixel data is transferred with use of different transfer rates in a first period in which the wireless communication is performed and in a second period in which the wireless communication is not performed.
   (10)

The program according to (9) above, in which
the pixel data is transferred at a first transfer rate corresponding to the predetermined frequency in the first period, and transferred at a second transfer rate higher than the first transfer rate in the second period.
   (11)

The electronic equipment according to (10) above, in which
a zero value is set for the first transfer rate to refrain from transferring the pixel data in the first period, while the pixel data is transferred at the second transfer rate in the second period.
   (12)

The program according to (8) above, in which
the wireless communication function is enabled to use first wireless communication in which wireless communication is performed at a first frequency and second wireless communication in which wireless communication is performed at a second frequency, and
the pixel data is transferred at a transfer rate corresponding to both the first frequency and the second frequency.
   (13)

The program according to any one of (8) through (12) above, in which
the transfer rate is changed in response to a change of a communication channel used in the wireless communication.
   (14)

The program according to any one of (8) through (13) above, in which
the function of transferring the pixel data transfers the pixel data from the pixel array section provided in plural number.

### REFERENCE SIGNS LIST

1: Electronic equipment
3a: Pixel array section
7: Wireless function section (wireless communication section)
f1: First frequency
f2: Second frequency
T1: First period
T2: Second period
TrA: Transfer rate
TrC, TrE: Transfer rate (first transfer rate)
TrB, TrD, TrF: Transfer rate (second transfer rate)

1. Electronic equipment comprising:
a wireless communication section that performs wireless communication using a band including a predetermined frequency; and
a pixel array section that transfers pixel data at a transfer rate corresponding to the predetermined frequency.

2. The electronic equipment according to claim 1, wherein
the pixel array section transfers the pixel data by using different transfer rates in a first period in which the wireless communication is performed and in a second period in which the wireless communication is not performed.

3. The electronic equipment according to claim 2, wherein
the pixel array section transfers the pixel data at a first transfer rate corresponding to the predetermined frequency in the first period, and transfers the pixel data at a second transfer rate higher than the first transfer rate in the second period.

4. The electronic equipment according to claim 3, wherein
the pixel array section sets a zero value for the first transfer rate to refrain from transferring the pixel data in the first period, while transferring the pixel data at the second transfer rate in the second period.

5. The electronic equipment according to claim 1, wherein
the wireless communication section is enabled to use first wireless communication in which wireless communication is performed at a first frequency and second wireless communication in which wireless communication is performed at a second frequency, and
the pixel array section transfers the pixel data at a transfer rate corresponding to both the first frequency and the second frequency.

6. The electronic equipment according to claim 1, wherein
the pixel array section changes the transfer rate in response to a change of a communication channel used in the wireless communication.

7. The electronic equipment according to claim 1, comprising:
the pixel array section in plural number.

8. A program readable by a computer apparatus, the program causing a computer apparatus to implement:
a wireless communication function of performing wireless communication using a band including a predetermined frequency; and
a function of transferring pixel data from a pixel array section at a transfer rate corresponding to the predetermined frequency.

9. The program according to claim 8, wherein
the pixel data is transferred with use of different transfer rates in a first period in which the wireless communication is performed and in a second period in which the wireless communication is not performed.

10. The program according to claim 9, wherein
the pixel data is transferred at a first transfer rate corresponding to the predetermined frequency in the first period, and transferred at a second transfer rate higher than the first transfer rate in the second period.

11. The electronic equipment according to claim 10, wherein
a zero value is set for the first transfer rate to refrain from transferring the pixel data in the first period, while the pixel data is transferred at the second transfer rate in the second period.

12. The program according to claim 8, wherein
the wireless communication function is enabled to use first wireless communication in which wireless communication is performed at a first frequency and second wireless communication in which wireless communication is performed at a second frequency, and
the pixel data is transferred at a transfer rate corresponding to both the first frequency and the second frequency.

13. The program according to claim 8, wherein
the transfer rate is changed in response to a change of a communication channel used in the wireless communication.

14. The program according to claim 8, wherein
the function of transferring the pixel data transfers the pixel data from the pixel array section provided in plural number.
